(19) United States
(12) Patent Application Publication
(10) Pub. No.: US 2024/0373531 A1
(43) Pub. Date: Nov. 7, 2024

(54) LED LAMP WITH BOSS AND SURGE PROTECTION MODULE

(71) Applicant: Chongyi Jingyi Lighting Product Co., Ltd, Ganzhou (CN)

(72) Inventor: Yaoquan HE, Ganzhou (CN)

(21) Appl. No.: 18/652,454

(22) Filed: May 1, 2024

(30) Foreign Application Priority Data
May 4, 2023 (CN) 2023210286531

(51) Int. Cl. H05B 45/52; F21V 23/00

(52) U.S. Cl. CPC H05B 45/52; F21V 23/002; F21V 23/005

(57) ABSTRACT

An LED lamp with a boss and a surge protection module includes an LED support, an LED driving chip, an LED chip and a surge protection module, wherein the LED support includes a sink-type receiving cavity, and a first electrode to a fourth electrode which are spaced in sequence; an internal boss of the sink-type receiving cavity is disposed on an upper surface of a bottom surface of the sink-type receiving cavity in a direction in which the bottom surface of the sink-type receiving cavity faces upward; the LED driving chip and the surge protection module are both disposed on the second electrode on an upper side of the internal boss; and the LED chip is disposed on the fourth electrode at a lower side of the internal boss.

### CROSS-REFERENCE TO RELATED APPLICATION

This application claims priority from the Chinese patent application 2023210286531 filed May 4, 2023, the content of which is incorporated herein in the entirety by reference.

### TECHNICAL FIELD

The present disclosure relates to the field of LED lamps, in particular to an LED lamp with a boss and a surge protection module.

### BACKGROUND

US patent document U.S. Pat. No. 8,124,988B2 discloses a light emitting diode (LED) lamp package structure, which includes a plurality of LEDs, a control integrated circuit, a circuit board, and four conductive supports which are respectively encapsulated in a package body. However, deformation of the supports may occur if the package structure disclosed in this patent document is heated rapidly in a soldering environment. In addition, the package structure lacks a reasonable surge protection design.

Chinese patent document CN217847951U discloses an LED support, an LED lamp bead and an LED lamp strip, wherein the LED support includes an insulating base, at least two first conductive terminals and at least two second conductive terminals, and the insulating base is provided with at least one concave cavity for accommodating an LED chip assembly; the insulating base is provided with a bottom wall, a first side wall and a second side wall disposed opposite to the first sidewall; the first side wall includes a first inclined surface which is connected to the bottom wall and forms an included angle of 30-60° with the bottom wall; each first conductive terminal each includes a first bonding pad portion and a first pin portion connected with the first bonding pad portion; each second conductive terminal includes a second bonding pad portion and a second pin portion connected with the second bonding pad portion; both the first bonding pad portions and the second bonding pad portions are disposed in the concave cavity; the first pin portions extend along the first side wall toward the bottom wall; and the second pin portions extend along the second side wall toward the bottom wall and extend to the first side wall. Although the LED support in this patent document has high structural reliability, its structure is excessively complicated, which is not conducive to improving the production efficiency and improving the yield, and in addition, it still lacks a reasonable surge protection design.

In view of this, it is necessary to develop a new LED lamp to solve the above technical problems.

### SUMMARY

In view of this, the present disclosure provides an LED lamp with a boss and a surge protection module, including:
an LED support, an LED driving chip, an LED chip and the surge protection module,
wherein
the LED support includes a sink-type receiving cavity, and a first electrode to a fourth electrode which are spaced in sequence;
the sink-type receiving cavity includes a bottom surface, and a circumferential side extending generally upward at a peripheral edge of the bottom surface to form the sink-type receiving cavity, wherein
an internal boss of the sink-type receiving cavity is disposed on an upper surface of the bottom surface of the sink-type receiving cavity in a direction in which the bottom surface of the sink-type receiving cavity faces upward;
the LED driving chip and the surge protection module are both disposed on the second electrode on an upper side of the internal boss; and
the LED chip is disposed on the fourth electrode at a lower side of the internal boss.

Preferably, in the LED lamp,
when the LED lamp is a plurality of LED lamps with signals in parallel, for any one LED lamp, the second electrode is configured to receive a signal input DIN and further transmit the signal input DIN to the LED driving chip, and the LED driving chip does not need to output signals to other LED lamps, the surge protection module on the second electrode is connected to the fourth electrode across the internal boss, the third electrode is configured to be connected to a negative electrode of a power source, and further connected to the LED driving chip, and the fourth electrode is configured to be connected to a positive electrode of the power source and the LED chip, and further connected to the LED driving chip across the internal boss; and
when the LED lamp is LED lamps with signals in series, for any one LED lamp, the first electrode is configured to receive a signal input DIN and is further connected to the LED driving chip, and the LED driving chip is connected to the third electrode, and a signal output DOUT is sent to a corresponding first electrode of other LED lamps through the third electrode, the second electrode is configured to be connected to a negative electrode of a power source, and further connected to the LED driving chip, the surge protection module on the second electrode is connected to the fourth electrode across the internal boss, and the fourth electrode is configured to be connected to a positive electrode of the power source and the LED chip, and further connected to the LED driving chip across the internal boss.

Preferably, in the LED lamp,
two ends of the internal boss abut against side faces of the sink-type receiving cavity.

Preferably, in the LED lamp,
an external boss of the sink-type receiving cavity is disposed on a lower surface of the bottom surface of the sink-type receiving cavity in a direction in which the bottom surface of the sink-type receiving cavity faces downward.

Preferably, in the LED lamp,
an internal boss of the sink-type receiving cavity is disposed at a center line position of an upper surface of the bottom surface of the sink-type receiving cavity in a direction in which the bottom surface of the sink-type receiving cavity faces upward.

Preferably, in the LED lamp,
an external boss of the sink-type receiving cavity is disposed at an outer side of the center line position in a direction in which the bottom surface of the sink-type receiving cavity faces downward.

Preferably, in the LED lamp,
the external boss includes a first external boss and a second external boss.

Preferably, in the LED lamp,
the first external boss is substantially parallel to the second external boss.

Preferably, in the LED lamp,
the external boss is substantially parallel to the internal boss.

Preferably, in the LED lamp,
the external boss limits three substantially parallel wires including a wire connecting a positive electrode of a power supply, a wire connecting a negative electrode of the power supply, and a wire receiving a signal input DIN.

Preferably, in the LED lamp,
two ends of the external boss are located in the bottom surface of the sink-type receiving cavity.

The present disclosure has the following beneficial effects:
1. in the present disclosure, the internal boss in the LED support not only increases the stability and strength of the LED support, but also can be configured to electrically isolate the plurality of the electrodes, and/or prevent wires connected to the LED support from being displaced. That is, in the present disclosure, not only can a short circuit during continuous tin electrodepositing between the LED support and the wires connected to the LED support be greatly reduced by the relevant bosses, the internal boss also helps to prevent the LED chip carried by the LED support from being displaced, and the LED support can be ensured to have sufficient stability, and is not easily deformed during rapid heating during welding.
2. In the present disclosure, the anti-surge function of the LED lamp is achieved through the surge protection module disposed at the corresponding electrode.
3. In the present disclosure, the stability and strength of the LED support can be further improved by the additional external boss, and the short circuit during continuous tin electrodepositing between the LED support and the wires connected to the LED support can be greatly reduced, and the wires can be well limited, and at least a part of heat conducted by the LED support can be further dissipated through the wires connected to the LED support, which is significantly different from other solutions in LED packaging in the prior art.

Therefore, according to the LED lamp disclosed in the present disclosure, the stability and heat dissipation of an LED package structure are significantly improved through relevant bosses, and at the same time, the anti-surge function is achieved through the surge protection module disposed on a specific electrode. Thus, in the present disclosure, the production efficiency and yield are comprehensively improved, and a failure rate caused by surges is reduced.

### BRIEF DESCRIPTION OF FIGURES

In order to illustrate the technical solutions of the embodiments of the present disclosure more clearly, the drawings required to be used in the embodiments will be briefly described below, and it should be understood that the following drawings illustrate only certain embodiments of the present disclosure and therefore should not be regarded as limiting the scope, and that other related drawings can also be obtained from these drawings without inventive steps for those of ordinary skill in the art.

FIG. 1 is a structural schematic diagram of any one LED lamp when a plurality of similar LED lamps are in a parallel relationship with each other according to an embodiment of the present disclosure;

FIG. 2 is a structural schematic diagram of any one LED lamp when a plurality of similar LED lamps are in a series relationship with each other according to an embodiment of the present disclosure;

FIGS. 3 to 4 are structural schematic diagrams of different viewing angles of an LED lamp according to an embodiment of the present disclosure;

FIGS. 5 to 6 are structural schematic diagrams of an LED support of the LED lamp according to the embodiment of the present disclosure at different viewing angles;

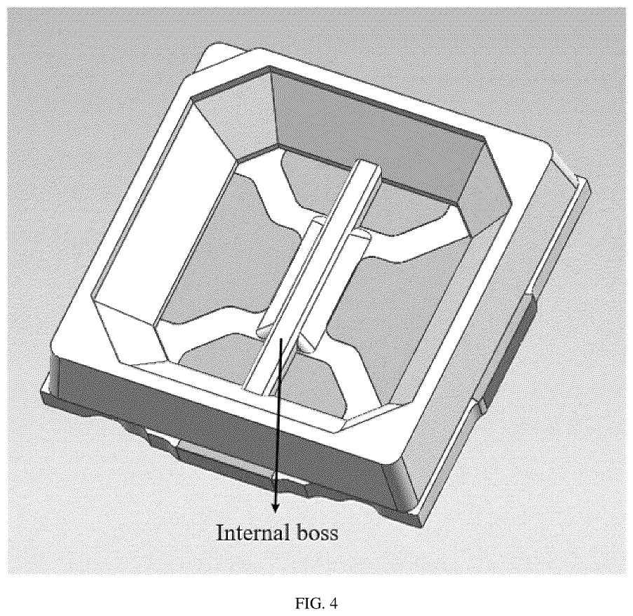

FIG. 7 is a cross-sectional schematic view of the LED support according to the embodiment of the present disclosure;

FIG. 8 is a structural schematic diagram of the LED support according to the embodiment of the present disclosure at one viewing angle;

FIG. 9 is a structural schematic diagram of an LED support different from that shown in FIG. 8 at one viewing angle according to an embodiment of the present disclosure;

FIG. 10 is a schematic diagram of connection and transmission when LED lamps with different LED supports are in a parallel relationship with each other in a signal line level according to an embodiment of the present disclosure; and

FIG. 11 is a schematic diagram of connection and transmission when LED lamps with different LED supports are in a series relationship with each other in sequence in a signal line level according to an embodiment of the present disclosure.

It should be noted that the above drawings do not limit the dimensional proportions between parts, and the drawings are more illustrative of the structure and connection relationship, the spatial position relationship, and the like.

### DETAILED DESCRIPTION

In order to make the objects, technical solutions and advantages of the embodiments of the present disclosure more clear, the technical solutions in the embodiments of the present disclosure will be clearly and completely described below with reference to the embodiments of the present disclosure and the accompanying drawings 1 to 11, and obviously, the described embodiments are some embodiments of the present disclosure, but not all of the embodiments. The components of the embodiments of the present disclosure generally described and illustrated in the drawings herein may be arranged and designed in a variety of different configurations.

Thus, the following detailed description of the embodiments of the present disclosure provided in the drawings is not intended to limit the scope of the present disclosure claimed, but is merely representative of the selected embodiments of the present disclosure. Based on the embodiments in the present disclosure, all other embodiments obtained by those of ordinary skill in the art without making inventive steps belong to the scope of protection of the present disclosure.

It should be noted that like reference numerals and letters represent like items in the following figures, and therefore, once an item is defined in one figure, it needs not be further defined and explained in the subsequent figures.

In the description of the present disclosure, it should be noted that the terms “upper”, “lower”, “inner”, “outer” and the like, if present, indicate an orientation or positional relationship based on the orientation or positional relationship shown in the drawings, or the orientation or positional relationship in which a product of the present disclosure is conventionally placed during use, are merely for ease of description of the present disclosure and for simplicity of description, and are not intended to indicate or imply that the device or element referred to must have a particular orientation, and be constructed and operated in a particular orientation, and therefore cannot be construed as limiting the present disclosure.

In addition, the terms “first,” “second,” etc., if present, are used only to distinguish descriptions and are not to be construed as indicating or implying relative importance.

It should be noted that the features in the embodiments of the present disclosure may be combined with each other without conflict.

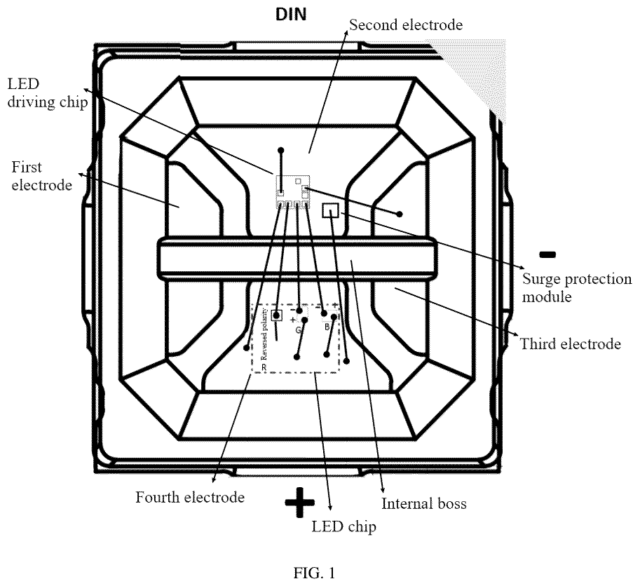

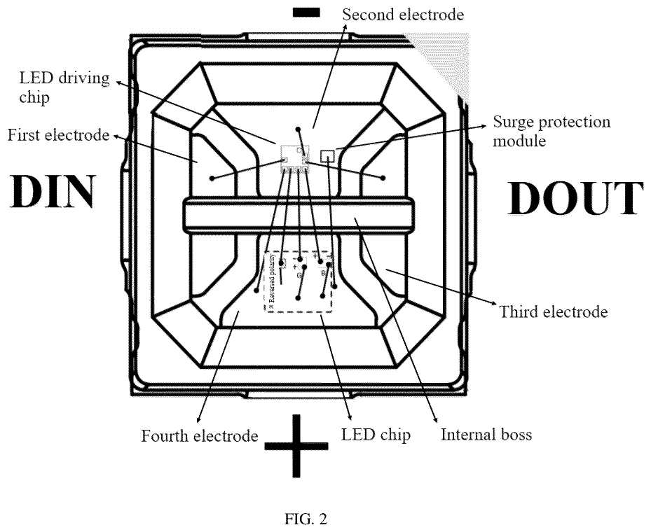

Referring to FIGS. 1 to 2, the present disclosure discloses an LED lamp with a boss and a surge protection module, including:
an insulating base, and a first electrode to a fourth electrode which are spaced in sequence; wherein
the insulating base is of a sink-type cup shape, and the insulating base is provided with a sink-type receiving cavity, wherein
a bottom of the insulating base constitutes a bottom surface of the sink-type receiving cavity;
a side wall of the insulating base extends generally upward at a peripheral edge of the bottom of the insulating base, constituting a peripheral side of the sink-type receiving cavity;
an internal boss of the sink-type receiving cavity is disposed on an upper surface of the bottom surface of the sink-type receiving cavity in a direction in which the bottom surface of the sink-type receiving cavity faces upward;
the LED driving chip and the surge protection module are both disposed on the second electrode on an upper side of the internal boss; and
the LED chip is disposed on the fourth electrode at a lower side of the internal boss.

Therefore, when a power supply wire or a wire transmitting an electrical signal is connected with the LED support, in the present disclosure, a short circuit during continuous tin electrodepositing that may be caused when the wire is welded is prevented by using the internal boss, and at the same time, during rapid heating during welding, the LED support can be ensured to have sufficient stability, and is not easily deformed, and it is also beneficial to prevent the displacement of the LED chip carried by the LED support. It can be understood that the sink-type receiving cavity may be configured to receive one or more LED light-emitting units. Generally, the LED light-emitting unit includes an LED chip, a driving chip/a control circuit of other functions, and the like. It should be noted that an angle at which the circumferential side of the sink-type receiving cavity extends generally upward depends on the reflective ability of the LED support to light emitted by the LED light-emitting unit carried by the LED support.

Taking FIG. 1 as an example, for a structure of any one LED lamp when a plurality of similar LED lamps are in a parallel relationship with each other, the LED chip includes, for example, three-color R, G, and B lamp beads, and a specified address code is burned for each lamp bead. At this time, a signal input DIN may take only one consecutive signal wire to connect the LED lamps in the form of a bus, for example, the signal wire is connected to the LED chip via the LED driving chip; and the surge protection module may then be disposed on the second electrode together with the LED driving chip. In this case, a detailed package structure includes the following features: when the LED lamp is a plurality of LED lamps with signals in parallel, for any one LED lamp, the second electrode is configured to receive a signal input DIN and further transmit the signal input DIN to the LED driving chip, and the LED driving chip does not need to output signals to other LED lamps, the surge protection module on the second electrode is connected to the fourth electrode across the internal boss, the third electrode is configured to be connected to a negative electrode of a power supply, and further connected to the LED driving chip, and the fourth electrode is configured to be connected to a positive electrode of the power supply and the LED chip, and further connected to the LED driving chip across the internal boss. It can be understood that the signal referred to in the present disclosure is used to perform a variety of controls on the brightness and flickering and color and the like of the lamp beads in a manner similar to data control.

Taking FIG. 2 as an example, for a structure of any one LED lamp when a plurality of similar LED lamps are in a serial relationship with each other, it is not necessary to burn a specified address code for each of the three-color R, G, and B lamp beads. The signal wire is divided into a signal input wire and a signal output wire, exemplarily, when a signal is transmitted to one LED lamp each time, the LED driving chip of the LED lamp directly reads the DIN signal transmitted, reads only the first few bits of the DIN signal, and outputs the remaining DIN signal in the form of a DOUT signal to a subsequent LED lamp of which an LED driving chip is processed in a similar manner as a previous LED driving chip in addition to the first few bits of the DIN signal. Therefore, in this case, it is not necessary to burn a specified address code for each LED lamp, at this time, the detailed package structure includes the following features: when the LED lamp is LED lamps with signals in series, for any one LED lamp, the first electrode is configured to receive a signal input DIN and is further connected to the LED driving chip, and the LED driving chip is connected to the third electrode, and a signal output DOUT is sent to a corresponding first electrode of other LED lamps through the third electrode, the second electrode is configured to be connected to a negative electrode of a power source, and further connected to the LED driving chip, the surge protection module on the second electrode is connected to the fourth electrode across the internal boss, and the fourth electrode is configured to be connected to a positive electrode of the power source and the LED chip, and further connected to the LED driving chip across the internal boss.

In summary, it can be understood that in the present disclosure, the anti-surge function of the LED lamp is also achieved through the surge protection module disposed at the corresponding electrode. It should be noted that the surge protection module may be a high-voltage pipe, a MOV, a varistor, or the like.

In another embodiment,
an external boss of the sink-type receiving cavity is disposed on a lower surface of the bottom surface of the sink-type receiving cavity in a direction in which the bottom surface of the sink-type receiving cavity faces downward.

It can be understood that in the present disclosure, the stability and strength of the LED support is further improved by the additional external boss, and a short circuit during continuous tin electrodepositing between the LED support and wires connected to the LED support can be greatly reduced, and the wires can be well limited, and at least a part of heat conducted by the LED support can be further dissipated through the wires connected to the LED support, which is significantly different from other solutions in LED packaging in the prior art. In addition, in the present disclosure, the external boss can play a role of limiting the wires, and at the same time, the stability of the package structure of the LED lamp is strengthened as a whole by using a double-sided boss formed by the internal boss and the external boss.

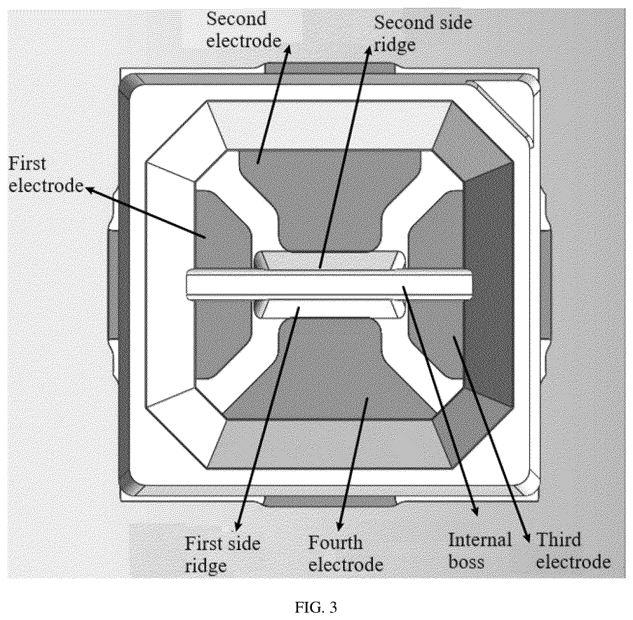

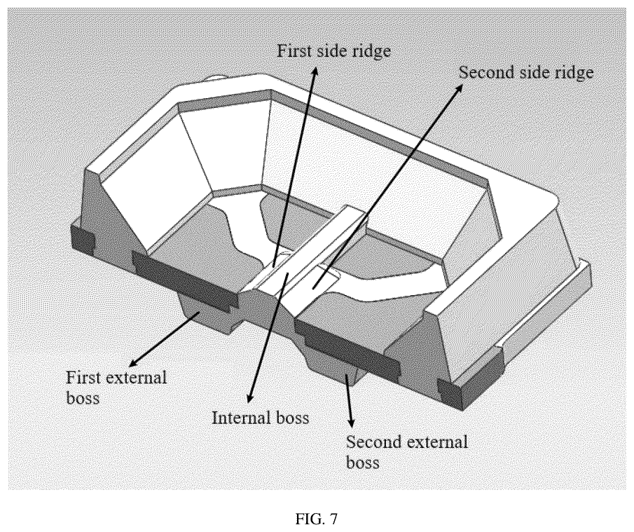

In addition, it can be found that in connection with FIGS. 3 and 8, the first electrode to the fourth electrode themselves are physically isolated from the perspective of the front and back, which may be sequentially spaced by 90 degrees.

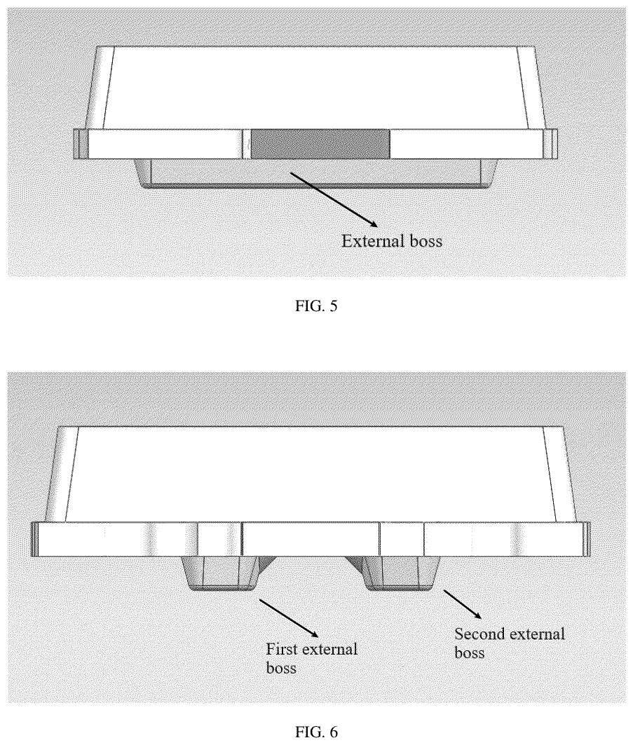

Referring to FIG. 7, the first electrode to the fourth electrode may space apart different regions of the bottom surface, and a complete bottom surface is formed by the first electrode, a first region of the bottom surface, the second electrode, a second region of the bottom surface, the third electrode, a third region of the bottom surface, the fourth electrode, a fourth region of the bottom surface, and the first electrode in sequence. And a thickness of any one electrode is equal to a thickness of the bottom surface. Further, with reference to FIG. 7, exemplarily, a length and a width of the bottom of the LED support exceeds a length and a width of a circumferential side wall, respectively, so that the bottom forms an outwardly extending edge/step, and the first electrode to the fourth electrode extend outwardly to the edge/step. This naturally benefits leads.

Further, referring to FIGS. 3, 4 and 7, a first side ridge and a second side ridge which are immediately adjacent to each other are disposed on both sides at an intermediate position of the internal boss, wherein a side surface of the first side ridge and a side surface of the second side ridge are inclined toward an outer side of the internal boss, and side surfaces of the internal boss are upright. It can be found that the first side ridge and the second side ridge enhance the structural stability of the LED support and are also beneficial to prevent a short circuit. In addition, either end of both ends of the internal boss abuts against a side wall to enhance the structural stability of the LED support. Exemplarily, the either end also extends into and divides a portion of area of an electrode. Exemplarily, in connection with FIGS. 3, 4 and 7, a length of the internal boss is approximately twice that of either side ridge. Further, the first side ridge and the second side ridge are equal in length, and the length of either side ridge is greater than a width of a head of the corresponding electrode (e.g., the second electrode or the fourth electrode) which is adjacent to or abuts against a slope of its side ridge, and a width of either side ridge is less than a width of a head of the corresponding other electrode (e.g., the first electrode or the third electrode) which is adjacent to or abuts against an end face of its side ridge.

In addition, with reference to FIG. 8, either electrode may be provided with a hollow region of the electrode on a lower surface of the bottom surface of the sink-type receiving cavity. Exemplarily, the hollow region of each electrode has a rounded rectangular shape. The hollow regions of the electrodes allow the electrodes to have a tensile effect when incorporated in the LED support, thus being more firmly incorporated.

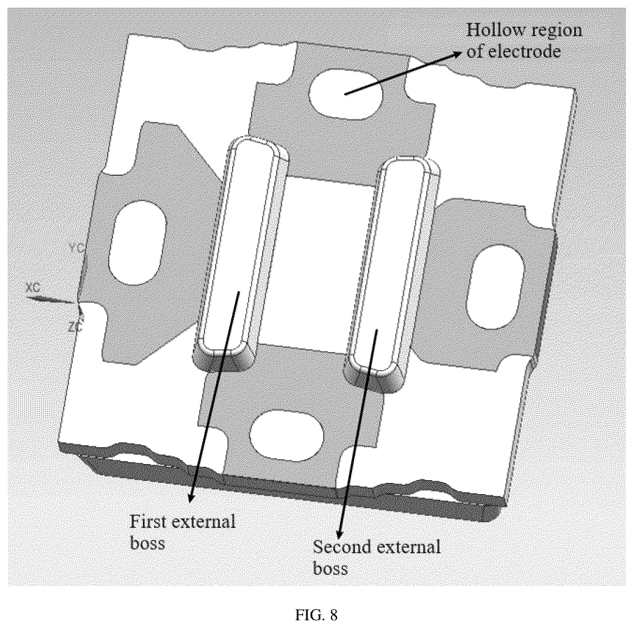

In another embodiment, FIG. 9 illustrates a first external boss and a second external boss which are longer in length compared with FIG. 8. And an oblique side ridge of the first external boss and an oblique side ridge of the second external boss are respectively disposed on opposite inner sides of the first external boss and the second external boss. It can be understood that the first external boss and the second external boss which are longer in length can better prevent short-circuiting around the boss while facilitating welding.

In one embodiment, referring to FIGS. 3 and 4,
an internal boss of the sink-type receiving cavity is disposed at a center line position of an upper surface of the bottom surface of the sink-type receiving cavity in a direction in which the bottom surface of the sink-type receiving cavity faces upward.

Preferably, in the LED support,
an external boss of the sink-type receiving cavity is disposed at an outer side of the center line position in a direction in which the bottom surface of the sink-type receiving cavity faces downward.

Preferably, in the LED support,

Two sides of the internal boss include at least two electrodes, which are isolated from each other, among the first electrode to the fourth electrode.

Referring to FIGS. 6 and 8, preferably, in the LED support,
the external boss includes a first external boss and a second external boss.

Preferably, in the LED support,
the first external boss is substantially parallel to the second external boss.

Referring to FIG. 7, it should be noted that the internal boss, the external boss, the first side ridge, and the second side ridge are all in a generally parallel relationship.

Preferably, in the LED support,
two ends of the external boss are located in the bottom surface of the sink-type receiving cavity. That is, the external boss does not extend beyond the bottom surface of the sink-type receiving cavity.

Preferably, in the LED support,
two ends of the internal boss abut against side faces of the sink-type receiving cavity.

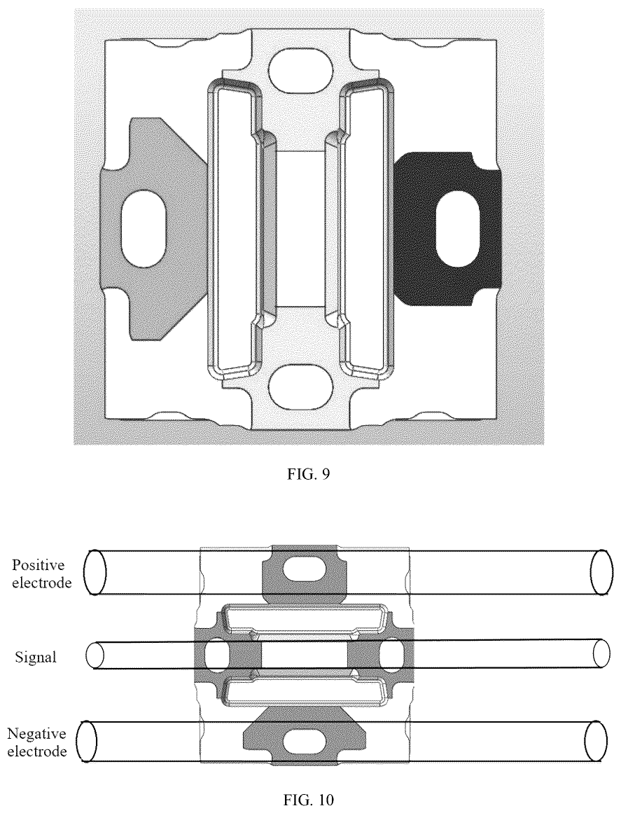

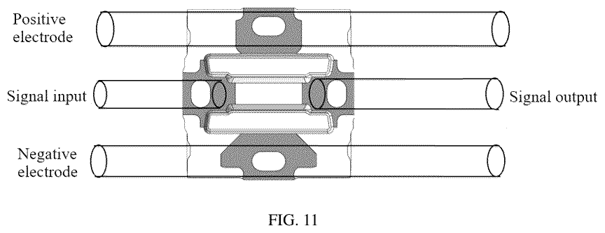

Preferably, in the LED support,
the LED support can be used for LED lamps with signals in parallel and LED lamps with signals in series. FIG. 10 illustrates the arrangement of three types of wires, a positive electrode wire, a signal wire, and a negative electrode wire when a signal wire other than a power supply line is used as a bus so that different LED light-emitting units are in a parallel relationship at a signal line level by taking DC driving as an example, and the case where signals are always connected to LED light-emitting units carried on each LED support in a bus manner along the signal wire. FIG. 11 illustrates the case where signals are sequentially input into and output from the LED light-emitting unit when different LED light-emitting units are in a series relationship at a signal line level. It can be understood that in order not to obscure the LED support of the present disclosure, the LED light-emitting units that the LED support needs to carry are not shown in the present disclosure. It can also be found from FIGS. 10 and 11 that the external boss at the bottom of the LED support well limits different wires.

The above are only the specific embodiments of the present disclosure, but the protection scope of the present disclosure is not limited thereto. Any change or replacement that can be easily thought of by a skilled person familiar with the technical field within the technical scope disclosed in the present disclosure should be covered within the scope of protection of the present disclosure. Therefore, the protection scope of the present disclosure should be subject to the protection scope of the claims.

What is claimed is:

1. An LED lamp with a boss and a surge protection module, comprising:
an LED support, an LED driving chip, an LED chip and the surge protection module, wherein the LED support comprises a sink-type receiving cavity, and a first electrode to a fourth electrode which are spaced in sequence;
the sink-type receiving cavity comprises a bottom surface, and a circumferential side extending generally upward at a peripheral edge of the bottom surface to form the sink-type receiving cavity, wherein
an internal boss of the sink-type receiving cavity is disposed on an upper surface of the bottom surface of the sink-type receiving cavity in a direction in which the bottom surface of the sink-type receiving cavity faces upward;
the LED driving chip and the surge protection module are both disposed on the second electrode on an upper side of the internal boss; and
the LED chip is disposed on the fourth electrode at a lower side of the internal boss.

2. The LED lamp according to claim 1, wherein when the LED lamp is a plurality of LED lamps with signals in parallel, for any one LED lamp, the second electrode is configured to receive a signal input DIN and further transmit the signal input DIN to the LED driving chip, and the LED driving chip does not need to output signals to other LED lamps, the surge protection module on the second electrode is connected to the fourth electrode across the internal boss, the third electrode is configured to be connected to a negative electrode of a power source, and further connected to the LED driving chip, and the fourth electrode is configured to be connected to a positive electrode of the power source and the LED chip, and further connected to the LED driving chip across the internal boss; and
when the LED lamp is LED lamps with signals in series, for any one LED lamp, the first electrode is configured to receive a signal input DIN and is further connected to the LED driving chip, and the LED driving chip is connected to the third electrode, and a signal output DOUT is sent to a corresponding first electrode of other LED lamps through the third electrode, the second electrode is configured to be connected to a negative electrode of a power source, and further connected to the LED driving chip, the surge protection module on the second electrode is connected to the fourth electrode across the internal boss, and the fourth electrode is configured to be connected to a positive electrode of the power source and the LED chip, and further connected to the LED driving chip across the internal boss.

3. The LED lamp according to claim 1, wherein two ends of the internal boss abut against side faces of the sink-type receiving cavity.

4. The LED lamp according to claim 1, wherein an external boss of the sink-type receiving cavity is disposed on a lower surface of the bottom surface of the sink-type receiving cavity in a direction in which the bottom surface of the sink-type receiving cavity faces downward.

5. The LED lamp according to claim 1, wherein an internal boss of the sink-type receiving cavity is disposed at a center line position of an upper surface of the bottom surface of the sink-type receiving cavity in a direction in which the bottom surface of the sink-type receiving cavity faces upward.

6. The LED lamp according to claim 5, wherein an external boss of the sink-type receiving cavity is disposed at an outer side of the center line position in a direction in which the bottom surface of the sink-type receiving cavity faces downward.

7. The LED lamp according to claim 4, wherein the external boss comprises a first external boss and a second external boss.

8. The LED lamp according to claim 7, wherein the first external boss is substantially parallel to the second external boss.

9. The LED lamp according to claim 4, wherein the external boss is substantially parallel to the internal boss.

10. The LED lamp according to claim 4, wherein the external boss limits three substantially parallel wires comprising a wire connecting a positive electrode of a power supply, a wire connecting a negative electrode of the power supply, and a wire receiving a signal input DIN.
